(19) United States
(12) Patent Application Publication
(10) Pub. No.: US 2020/0127844 A1
(43) Pub. Date: Apr. 23, 2020

(54) APPARATUS, SYSTEMS, AND METHODS FOR STEMMED BLOCKCHAIN OPERATION WITH SECURED PARTICIPANT IDENTITIES

(71) Applicant: Vopy Technology AS, Gjettum (NO)

(72) Inventors: Frode van der Laak, Gjettum (NO); Zane Dawood, Toronto (CA)

(21) Appl. No.: 16/660,759

(22) Filed: Oct. 22, 2019

Related U.S. Application Data
(60) Provisional application No. 62/749,649, filed on Oct. 23, 2018.

(51) Int. Cl. H04L 9/32; H04L 9/06

(52) U.S. Cl. CPC H04L 9/3239; H04L 9/3247; H04L 2209/56; H04L 2209/38; H04L 9/0637

(57) ABSTRACT

Electronic transaction systems and methods are operable to generate a plurality of branch blockchains using selected transaction information that is provided by a trunk and branch transaction block generation system. An transaction block generator system comprising a rate monitor module, a blockchain rule module, a transaction receiver module, an order module, and a block generation module is described which generates a trunk blockchain and one or more branch blockchains to overcome transaction saturation problems as well as for other reasons such as for multi-tenancy, including handling of different financial processing systems, protocols, privacy, security, and the like. In one embodiment a branch transaction block generator system can checkpoint some portion or all of its blockchain into a parent transaction block generator system.

### CROSS-REFERENCE TO RELATED APPLICATION

This application claims the benefit of priority from U.S. Patent Application No. 62/749,649 filed Oct. 23, 2018, the contents of which application is incorporated herein by reference in its entirety.

### TECHNICAL FIELD

The present disclosure relates to systems, methods, and techniques for blockchain networks and, in particular, to improved systems, methods, and techniques for handling scalability, protocol diversity, and identity verification.

### BACKGROUND

Blockchain technology provides a secure and reliable process of storing transaction ledgers or other information in discrete blocks of secure information using a distributed networked system of decentralized computer system nodes. The nodes are sometimes referred to as peer systems and the network as a peer to peer computing network. Each secure block of information, once created and validated, is reproduced and is stored at multiple devices in the peer to peer system as part of an ordered sequence of blocks, interchangeably referred to herein as a blockchain. Such blocks of information are secure because a block has a particular and unique hash value that is generated based on the information contents of the that particular block. If any one of the plurality of like blocks that are stored in a distributed fashion is tampered with or is hacked, the data within the tampered block changes. As a result of the changed data, the hash value computed with the modified information in the tampered-with block will not equal the original hash value. Accordingly, the tampered-with block is immediately recognizable as being invalid (tampered with). In many blockchain networks, several peers are requested to validate the same proposed (update) block and, if a consensus of validation is reached by the peers (e.g., such as if no tampering has occurred in one r more of the blocks being validated), the proposed block can then be added to the chain of blocks representing the transaction ledger.

New individual blocks are periodically generated to store new information. As a new block is generated, the hash value of the previous block is stored into the new block so that the subsequent block is are effectively back linked together with the previous block (and is thereby linked back to all previous linked blocks in the blockchain). That is, when the new block is generated, the hash value of the previous block is inserted, and optionally along with the block date (e.g., a transaction). The hash value for that new block is computed and stored into the block. When the new block has been generated, the new block has the has value of the previous block, the new information, and its hash value. When the next block is created, that next block will have the hash value of this new block, its own new information, and its own hash value. Thus, a time sequenced series of blocks are “chained” together since each individual block has its own hash value and the hash value of the immediately preceding block. Before a proposed block is committed into the blockchain (the ledger updated), the block is validated by typically multiple peer nodes, where each node compares the hash value of the previous block to the current hash value of its stored copy of the previous block to determine whether the block is valid. This process is known as consensus.

However, two limiting problems arise when a blockchain is used to store ledger information which documents a series of financial transactions pertaining to the transfer of funds (money, digital currency, or the like) from a sending party to a receiving party. A first problem is that transaction participants are identified using an account number or other like electronic identifier and suffer from trust and identity problems. Specifically, each transaction recorded into the ledger indicates an account of the sending party where the transaction funds are debited and indicates the account of the receiving party where the transaction funds are credited. However, because the people who own the accounts are not identified in the ledger (only the account numbers are included in the ledger), such transactions are anonymous.

Various problems arise with anonymous transactions. First, they are secretive and may be used by unscrupulous individuals for illegal purposes. Governments do not like such transactions since the transaction parties are not identified. And, the receiving party does not know “who” they are dealing with. For example, the sending party may be a seller of physical goods. They may receive a transaction request for purchase of their goods, but they may not be certain of the purchaser's identity. For example, the receiving party selling goods might be concerned that the purchasing person is a minor who is trying to purchase the receiving party's goods, which may have a minimum age requirement. So, the first significant problem with legacy blockchain technologies is the trust issues that arise with anonymous transactions.

A second problem that arises with legacy blockchain technologies is the saturation problem. A legacy blockchain acting as a ledger manager for a series of transactions has a limited number of maximum transactions that the blockchain can handle during a particular duration. For example, the well-known Bitcoin blockchain generates a new block every ten minutes. Approximately seven transactions per second is the maximum transaction rate that can be accommodated by the Bitcoin blockchain ledger system. Accordingly, the ledger information stored in any given block of the Bitcoin blockchain is limited to 4,200 transactions over a ten-minute duration. If the actual transaction rate reaches the maximum transaction rate that can be supported by a particular blockchain, the blockchain becomes saturated and transactions are dropped. That is, not all transaction can be accommodated. Large entities, such as internet retailers or the like, conduct transactions at a rate that is far in excess of the Bitcoin blockchain transaction rate, and accordingly, are unable to use the legacy Bitcoin blockchain technology for management of their transaction ledgers.

Further information regarding blockchain technology as used to support cryptocurrencies such as Bitcoin and Ethereum can be found in “What is Blockchain Technology,” published by “blockgeeks.com,” updated Sep. 13, 2018, and Nakamoto, Satoshi “Bitcoin: A Peer-to-Peer Electronic Cash System”, 24 May 2009, downloaded from “bitcoin.org/bitcoin.pdf,” which are herein incorporated by reference in their entireties. Other blockchain technologies, uses, and architectures exist, such as the open source effort by The Linux Foundation, called Hyperledger Fabric. Information on Fabric is available from “A Blockchain Platform for the Enterprise,” downloadable at “hyperledger-fabric.readthedocs.io/en/latest/getting_started.html,” which is incorporated herein by reference in its entirety.

Some blockchain technologies have been created to support a higher transaction rate. However, increasing the maximum transaction rate ten-fold, or even a hundred-fold, is not sufficient for a large-scale retail transaction system in which multiple large transaction volume retailers may wish to participate in. Accordingly, there is a need in the arts to provide a block chain technology that supports an unlimited transaction rate.

### BRIEF DESCRIPTION OF THE DRAWINGS

Embodiments are described in detail below with reference to the following drawings:

FIG. 1 is an example embodiment of a transaction tracking system in a peer-to-peer network environment; and

FIG. 2 is a block diagram showing additional detail of an exemplary transaction block generator system;

FIG. 3 is a block diagram showing additional detail of an exemplary transaction block generator system and a newly created branch transaction block generator system;

FIG. 4 is a conceptual illustration of a hypothetical trunk blockchain and a plurality of branch blockchains that are generated for the trunk blockchain at various times;

FIGS. 5A, 5B and 5C are a flow chart describing an exemplary process performed by an example embodiment of the transaction tracking system; and

FIG. 6 is an example block diagram of an example computing system that may be used to practice embodiments of a transaction block generator system.

### DETAILED DESCRIPTION

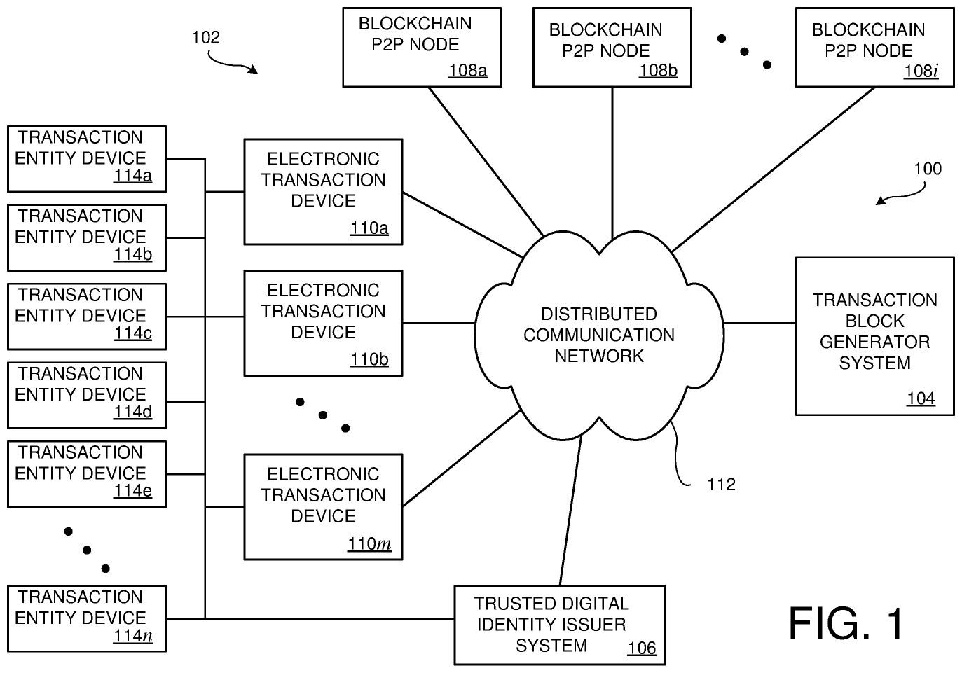

FIG. 1 is a block diagram of an example embodiment of a transaction tracking system 100 in a peer-to-peer network environment 102. The non-limiting illustrated embodiment of the transaction tracking system 100 comprises at least one transaction block generator system 104 and at least one trusted digital identity issuer system 106 that are in communication with other peer-to-peer nodes in the network environment 102. Other nodes in the network environment 102 include a plurality of blockchain peer-to-peer (P2P) nodes 108a-i and one or more electronic transaction devices 110a-m. Other types of peer-to-peer nodes (not shown) may be included in the peer-to-peer network environment 102 that perform other or subsets of functionality. The nodes of the peer-to-peer network environment 102 are communicatively coupled together via a distributed communication network 112.

The transaction block generator system 104 generates the blocks of a block chain. In general terms, a blockchain is an immutable transaction ledger, maintained within a distributed network of peer-to-peer nodes. These peer-to-peer nodes each maintain a copy of the ledger by applying transactions that have been validated by a consensus protocol, grouped into blocks that include a hash that bind each block to the preceding block. These blocks, chained together by their hashes, is know in the arts as a blockchain.

In one application, the blocks include transaction information that describes various transactions that are occurring inside or outside of the peer-to-peer network environment 102. Any suitable transaction information may be stored in the blocks of a blockchain generated by the transaction block generator system 104. For example, financial transaction information as well as supply-chain, chain-of-custody information, business use case examples, or other information whose security is of interest (and typically involving transactions between multiple parties) may be stored as transaction information. In other applications, other information may be stored in the blocks of a blockchain. For example, meta-data information related to the transaction or the identities of participants in the transaction may be stored as well. As is appreciated by one skilled in the art, any information stored in the blocks of a blockchain is secure and reliable by the very nature of storage of the blockchains in a plurality of different locations across the peer-to-peer network environment 102.

In the example peer-to-peer network environment 102 of FIG. 1, the blockchain P2P nodes 108 store the generated blocks that are broadcast onto the peer-to-peer network environment 102. In some situations, a blockchain P2P node 108 may optionally store only the most current block (rather than all of, or part of, the blocks that make up the blockchain). In some situations, when a new blockchain P2P node 108 enters into the peer-to-peer network environment 102, the new blockchain P2P node 108 accesses and stores the blockchain(s) that are stored on other ones of the blockchain P2P nodes 108 (e.g., a copy of the entire or a portion of the “ledger”—which represents the transaction history). In some applications, the stored blockchains (interchangeably referred to herein as the ledger) may include the most recent transaction information for all transactions, also known as the current state of the transactional system to enable quickly bringing on a new P2P node. (Any transactions received after that point are meant to update the last current state of the blockchain.) The blockchain P2P nodes 108 may perform other functionality in additional to the storage and management of their stored blockchains. If multiple blockchains are generated by other transaction block generator systems (not yet shown), the blockchain P2P nodes 108 may optionally store those other blockchains. In addition, P2P nodes 108 may perform other services such as certificate or authentication services or may perform other services not related to processing blockchains.

The electronic transaction devices 110a-m are devices that conduct transactions with one or more transaction entity devices 114a-n. In a non-limiting application, the electronic transaction devices 110a-m are operated by a vendor of goods and/or services, interchangeably referred to herein as a provider. The transaction entity devices 114a-n are devices operated by a consumer. Other architectures and/or uses of the P2P network can be similarly accommodated. In some cases, one can refer to a provider of transaction data as a producer and a recipient of transaction data as a data consumer.

For example, vendor A may operate a website (illustrated as the electronic transaction device 110a) that a consumer accesses, using one of their transaction entity devices 114, to purchase a product and/or service offered by the vendor A. FIG. 1 illustrates a transaction entity device 114a that is communicatively coupled to the electronic transaction devices 110a operated by vendor A. (The transaction entity device 114a is also illustrated in FIG. 1 as being communicatively coupled to the other electronic transaction devices 110b-i that are operated by other vendors, or even by vendor A).

The request to purchase the product and/or service from a consumer is either accepted or rejected by the provider. If the purchase request from the consumer is accepted, and a payment from the consumer to the provider is made, and the provider commits to providing the product and/or service. The result is known as a “transaction” in the arts. The transaction identifies at least the consumer, the vendor, and the nature of the agreement (what product and/or service is being purchased and the agreed upon price). In other applications, any suitable transaction may be agreed to between an entity operating an electronic transaction device 110a-m and an entity operating a transaction entity devices 114a-n. For example, transactions involving supply chain auditing for verification of where a product is at any time, who handled it, how it was transported, etc. may be verified using transaction processing available through blockchain techniques.

Examples of a transaction entity device 114a may be a personal computer that is owned, or that is being operated by, a consumer. Other non-limiting examples of a transaction entity device 114a include a smart phone, a mobile device, a personal device assistant, a vending machine, or any other suitable electronic-based device that can be operated by an individual or entity to initiate a transaction with another individual or entity. Of note, although shown as outside the distributed communication network 112, the transaction entity devices 114a-n may be one of the other systems, including the P2P nodes 108a-i, connected to network 112.

A particular problem encountered in the arts is “trust.” For example, the party or entity initiating the transaction may not be known to the provider. Typically, a transaction identifies the consumer by a suitable account identifier, and optionally, the name or the like of the consumer. For example, the transaction may include the credit card information (account information) and the name John Doe, the purported name of the consumer. In practice, the transaction can be completed based on the consumer's account information only since the payment is received by the provider from the identified account.

However, the provider may not choose to complete the transaction because the identity of the consumer may be in question. For example, the product may be adult oriented, and the provider would otherwise want to be assure that the consumer is old enough to acquire the adult product (such as tobacco, liquor, cannabis products, pornographic, or other regulated products). As another example, the product sale may be restricted to certain qualified individuals (such as in the case of purchase of firearms or ammunition for firearms). As another example, the transaction request may be for the purchase of stocks or other financial instruments that may be made only be an authorized broker. In the absence of proof of identity of the requesting party or entity, the producer may be reluctant to accept the transaction request.

An example embodiment solves the problem of trusted identity by having a designated party or entity, operating the trusted digital identity issuer system 106, provide a trusted digital identity document to the consumer. FIG. 1 illustrated the trusted digital identity issuer system 106 that is communicatively coupled to the plurality of transaction entity devices 114a-n. The party or entity operating a particular one of the transaction entity devices 114a-n initiates a request for a trusted digital identity document to the trusted digital identity issuer system 106. The party or entity will be required to provide various proof of identity information to the operator to the trusted digital identity issuer system 106. Once the operator of the trusted digital identity issuer system 106 is satisfied as to the truthfulness of the, the trusted digital identity issuer system 106 issues a trusted digital identity document to the requesting party or entity.

The trusted digital identity document includes information that identifies the requesting party or entity. The trusted digital identity document further includes information that identifies the operator who issued the trusted digital identity document. Preferably, the operator of the trusted digital identity document is known to the various producers who are operating the electronic transaction devices 110a-m. Prior to receiving authorization for the operator of the trusted digital identity issuer system 106 to issue trusted digital identity documents, the operator may have gone through a validation process that is conducted by the producers and/or by a trusted third party reviewer.

The trusted digital identity document preferably includes other verified supplemental information pertaining to the consumer. Such verified supplemental information may include personal information such as the age, date of birth, location of birth, identities of relations, place of work, employment history, or the like. Additionally, or alternatively, the verified supplemental information may include financial account information, such as the account information that identifies the account that the consumer has identified as being the source of funds for payment of the requested transaction.

With the various embodiments of the transaction tracking system 100, a transaction request from a consumer includes the trusted digital identity document. After the provider is satisfied with the identity of the consumer, and agrees to complete the transaction, the transaction particulars are saved to memorialize the transaction. In an example embodiment, the transaction particulars include the trusted digital identity document. In contrast, prior art transactions include the account information of the consumer, the account information of the provider, and a description of the agreed-to goods and/or services, and the agreed price for the goods and/or services. Now, when the transaction information includes the trusted digital identity document of the consumer, issues of anonymity are resolved and available for each transaction. For example, a government oversight agency can later access the stored transaction information and be able to ascertain with certainty the identity of the consumer. Current blockchain technologies do not store this information even when identity services such as certificate authorities are used. It is the storage of this information with the transaction that elevates the transaction from anonymous to associated with a particular individual. This capability enhances potential use of blockchain technology for business enterprise level, government, and other transactions where anonymity may be a detriment to the use of blockchain technologies it that particular application arena.

In some embodiments, the trusted digital identity issuer system 106 is also a member of the peer-to-peer network environment 102. Accordingly, the trusted digital identity issuer system 106 may store and/or access the blockchains to obtain historical transaction information that has been securely stored in the blockchains for later review and/or analysis.

To memorialize the transaction, the particulars of the transaction (interchangeably referred to herein as transaction information) are communicated from the electronic transaction device 110 to the transaction block generator system 104. The transaction block generator system 104 receives other transaction information from all of the electronic transaction devices 110a-m. All received transaction information is saved over a certain period of time (a predefined duration) by the transaction block generator system 104. At the end of the duration, the transaction information is aggregated and stored into a block of data, interchangeably referred to as a block. A hash value that is unique to the generated block is computed. Also, the hash value for the previously generated block (that was generated for the immediately preceding period of time) is included into the newly generated block. The newly generated block is then broadcast onto the peer-to-peer network environment 102 and is saved by the blockchain P2P nodes 108. As will be described below, in some embodiments described herein, certain parameters and protocols used to define the block may be specified as part of the block generation for a particular type of blockchain.

The distributed communication network 112 is illustrated as a generic communication system. In one embodiment, the distributed communication network 112 comprises a cellular telephone system, such as a radio frequency (RF) wireless system. Accordingly, the various member devices of the peer-to-peer network environment 102 include a suitable transceiver. Alternatively, the peer-to-peer network environment 102 may be a telephony system, the Internet, a Wi-fi system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. Additionally, member devices of the peer-to-peer network environment 102 may be implemented to communicate using other types of communication technologies, such as but not limited to, digital subscriber loop (DSL), X.25, Internet Protocol (IP), Ethernet, Integrated Services Digital Network (ISDN) and asynchronous transfer mode (ATM). Also, embodiments of the distributed communication network 112 may be configured to communicate over combination systems having a plurality of segments which employ different formats for each segment that employ different technologies on each segment.

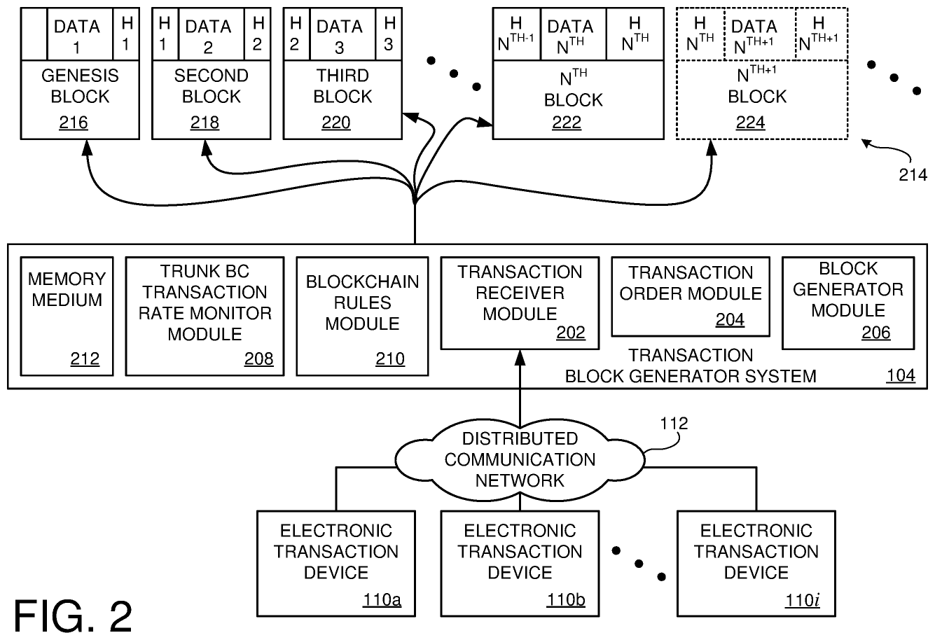

FIG. 2 is a block diagram showing additional detail of an exemplary transaction block generator system 104. The transaction block generator system 104 comprises a transaction receiver module 202, a transaction order module 204, a block generator module 206, a trunk blockchain (BC) transaction rate monitor module 208, a blockchain rules module 210, and a memory medium 212. Other embodiments may include other blocks and/or modules (not shown) that provide other functionality. Alternatively, or additionally, one or more of the blocks and/or modules of FIG. 1 may be integrated together and/or may be integrated with other blocks and/or modules. In the various embodiments, the blocks and/or modules of FIG. 1 may be implemented as hardware, firmware, or a combination of hardware and firm ware. In some embodiments, the blocks and/or modules of a transaction block generator system 104 may be implemented in a distributed fashion using a plurality of peer-to-per devices networked together via the distributed communication network 112.

The transaction receiver module 202 communicatively couples, via the distributed communication network 112, the transaction block generator system 104 to the plurality of electronic transaction devices 110a-m. As transaction are completed by one of the electronic transaction devices 110a-m, the transaction information for the completed transaction is communicated to the transaction block generator system 104. Each received transaction information is identified by the transaction receiver module 202. In some embodiments, the transaction receiver module 202 adds supplemental information of interest that is associated with each received transaction information. For example, an identifier (supplemental information) that identifies the transmitting one of the electronic transaction devices 110a-m may be added into the transaction information. Another type of supplemental information is a time stamp, geographic location, or the like that identifies the time and/or location of the transact and/or a time and/or location that the transaction information was generated and/or was received. Any suitable supplemental information of interest may be incorporated into the transaction information, either directly into the information or as associated metadata.

In some embodiments, a plurality of transaction receiver modules 202 are used to communicatively couple to different ones of the plurality of electronic transaction devices 110a-m. For example, the various electronic transaction devices 110a-m may each use different communication formats and/or provide the transaction information in various formats.

Each received transaction information is communicated to the transaction receiver module 202 to the transaction order module 204. The transaction order module 204 manages storage of the received transaction information into the memory medium 212 of the transaction block generator system 104. Each transaction information is stored as a transaction information entry. Various data storage formats and processes may be used to store each received transaction information. In an example embodiment, the transaction order module 204 formats the transaction information into a suitable transaction information entry for storage into a block when the block is generated by the block generator module 206 and determines a relevant order for the transactions within the block. This order may be based upon the type of transactions being processed, time of transactions, or other characteristics. As with other blockchain technologies, the precise order may be less important than that the order is immutable. That is, the ordering of data and the content of the data in a block does not chain within the block once the block has been generated and stored by the P2P nodes within the P2P network.

Periodically, the block generator module 206 accesses the acquired transaction information entries that are stored in the memory medium 212. The accessed transaction information entries that are added into a block are those transaction information entries that were received during the current time period (or duration). Here, a new time period starts after a current time period ends (and the block containing the current transaction information entries is generated and its hash value determined). As new transaction information entries are accumulated into the memory medium 212, these newly acquired transaction information entries are associated with a new current time period. Thus, at the end of the new current time period, the transaction information entries acquired and stored for this new time period are accessed from the memory medium 212 by the block generator module 206, and a new block is generated.

FIG. 2 conceptually illustrates a hypothetical trunk blockchain 214 (also referred to in an exemplary system as a STEM chain). Each blockchain begins with a first block, the genesis block 216. The genesis block 216 is comprised of the initially received and stored transaction information entries for a first time period, which is conceptually represented as the DATA 1 portion of the genesis block 216. As part of the generation process, a unique hash (H1) or other equivalent encryption value is determined based on the stored plurality of transaction information entries in the DATA 1 portion. The generated genesis block 216 is then broadcast out to the blockchain P2P nodes 108 via the distributed communication network 112. Each blockchain P2P node 108 stores the received genesis block 216 (if it is a P2P node responsible for storing a transaction ledger). Depending upon the embodiment, the blockchain P2P nodes 108 may perform various operations of the received genesis block 216, such as a validation process or the like.

Newly generated transaction information entries (that are generated based on newly received transaction information) begin to be stored into the memory medium 212 for the next time period (the second time period). At the end of the second time period, the block generator module 206 retrieves the transaction information entries for the second time period and the previously computed hash value H1 for the genesis block 216. A new hash value H2 is computed for this second block 218 based on the accessed transaction information entries and optionally the hash value of the previous block (here, the hash H1 of the genesis block 216). The resultant second block 218 includes the hash H1 (of the previous block), the transaction information entries (DATA 2) acquired during the second time period, and the computed hash H2. This second hash block is then broadcast to the blockchain P2P nodes 108 via the distributed communication network 112. Then, depending upon the implementation, each blockchain P2P node 108 stores the received second block 218 as a member of its stored trunk blockchain 214. Alternatively, or additionally, if the information in DATA 2 represents a current and complete state information for all transactions, only the second block 218 need be stored by the blockchain P2P nodes 108. Alternatively, or additionally, a current state information of the blockchain may be also generated and separately stored on receiving P2P nodes.

The process of generating blocks continues on an ongoing basis. For example, the third block 220 for the third time period will comprise the accumulated transaction information entries acquired during the third time period, the hash H2 of the second block (the immediately preceding block in the trunk blockchain 214), and the computed has H3 for the third block 220 (which is computed based on the transaction information entries in DATA 3 and optionally, the second hash value H3).

The process of generating blocks for the trunk blockchain 214 is ongoing. For example, the N^{th} block 222 would be generated at the end of the current time period. This Nth block has the previous hash (HN^{th-1}), the new data, and the current hash value (H N^{th}).

Looking forward in time, a yet-to-be generated N^{th+1} block 224 is conceptually illustrated. This yet-to-be generated N^{th+1} block 224 will comprise the N^{th+1} data, the last hash value of the previous lock (HN^{th}) and its computed hash value HN^{th+1}.

One skilled in the art appreciates that the electronic transaction verification system 102 has a limited transaction capacity due to a variety of system limitations including processing and/or input/output (I/O) device access. For example, the well known Bitcoin blockchain system is limited to approximately seven transactions per second. Even with the newer advanced blockchain technologies used by embodiments of the transaction tracking system 100, there still will be a limit to the rate at which transaction information can be acquired and processed into blocks. If the current rate of incoming transaction information, interchangeably referred herein as the actual or current transaction rate, approaches the transaction rate threshold, the transaction tracking system 100 is defined to be entering into a state of transaction rate saturation.

In a legacy blockchain system, once the rate of incoming transaction information exceeds the transaction rate threshold, flooding will occur. During flooding, incoming transaction information is lost, dropped, or is otherwise omitted from a generated block for that particular time period. In other scenarios, the operation of portions of the legacy blockchain network, or even the entirety of the legacy blockchain network, may fail.

Embodiments of the transaction tracking system 100 uniquely solve the above-described transaction rate saturation threshold problem. The trunk BC transaction rate monitor module 208 monitors the rate of incoming transaction information, interchangeably referred to herein as the transaction rate. This monitored transaction rate is compared with a predefined transaction rate threshold. The predefined transaction rate threshold may be less than the actual transaction rate threshold by some predefined amount defined by the operators of the transaction tracking system 100, thereby providing a degree of margin or monitoring error in the system to improve operational reliability.

When the current transaction rate reaches the predefined transaction rate threshold, a new “trunk” blockchain is created. In the various embodiments, the transaction block generator system 104 causes another system, referred to herein as a branch transaction block generator system, to generate the new blockchain, referred to herein as a branch blockchain.

Transaction information entries have various attributes that can be used to differentiate those transaction information entries of interest (that are to be processed by a new branch transaction block generator system) from other transaction information entries that are to be processed by the transaction block generator system 104. In the various embodiments, one or more particular transaction information entry attributes are used to identify a particular group of related transaction information entries. These related transaction information entries are selected and then passed onto the branch transaction block generator system which generates the new branch blockchain using those received and related transaction information entries.

For example, assume that the branch transaction block generator system is created and initialized during the time period associated with the N^{th} block 222. Since the amount of remaining transaction information entries that are to be included in the yet-to-be generated N^{th+1} block 224 has been reduced (by virtue of passing the selected related transaction information entries to the new branch transaction block generator system), then all incoming transaction information can be accommodated in either the continuing trunk blockchain 214 or in the newly generated branch blockchain (to be generated by the branch transaction block generator system).

Another unexpected benefit of embodiments of the transaction tracking system 100 is that a new branch transaction block generator system can be created for a variety of other reasons. For example, specialty branches can be created and designed for processing based upon particular financial processing systems (financial “multi-tenancy” systems) such as to handle credit card processing versus cryptocurrency transaction resolution. Or, for example, a branch that is designed to employ additional or alternative hash functions or encryption which uses data from additional sources such as biometric feedback or other sensors. Or, for example, a specialty branch that works with certain P2P nodes (for example, via an access control list) may be designated for providing private or additional secure transactions. The blockchain rules module 210 contains a variety of rules that may be used to determine when and/or why a new branch transaction block generator system is to be created and how such branch blockchains interconnect with the trunk and/or other branch blockchains.

In an example embodiment, a particular client entity, such as a corporation or the like, may wish to have their transaction information incorporated into a new blockchain that is separate and distinct from the trunk blockchain 214. Here, a specification is communicated to the transaction block generator system 104 that causes the blockchain rules module 210 to cause the formation of a new branch transaction block generator system. Then, incoming transaction information associated with this particular client entity may be sent to the new branch transaction block generator system for incorporation into the new blockchain.

Alternatively, or additionally, a new blockchain protocol may be desired for some reason of interest. This new blockchain may be created by the new branch transaction block generator system using the different blockchain generation format.

Alternatively, or additionally, a different security and/or access protocol may be desired. This new blockchain may be created by the new branch transaction block generator system using the different security and access protocols.

Any suitable rule for causing the generation of a new branch transaction block generator system that generates a new branch blockchain may be used by the various embodiments. Further, the rules residing in the blockchain rules module 210 may be revised at any time by the operator of the transaction tracking system 100. In addition, specific rules may be associated with and forwarded to the resulting new branch blockchain and perpetuated through the chain itself. Alternatively, and/or additionally, new branch transaction block generators may be dynamically defined and integrated into the system while the system is operating.

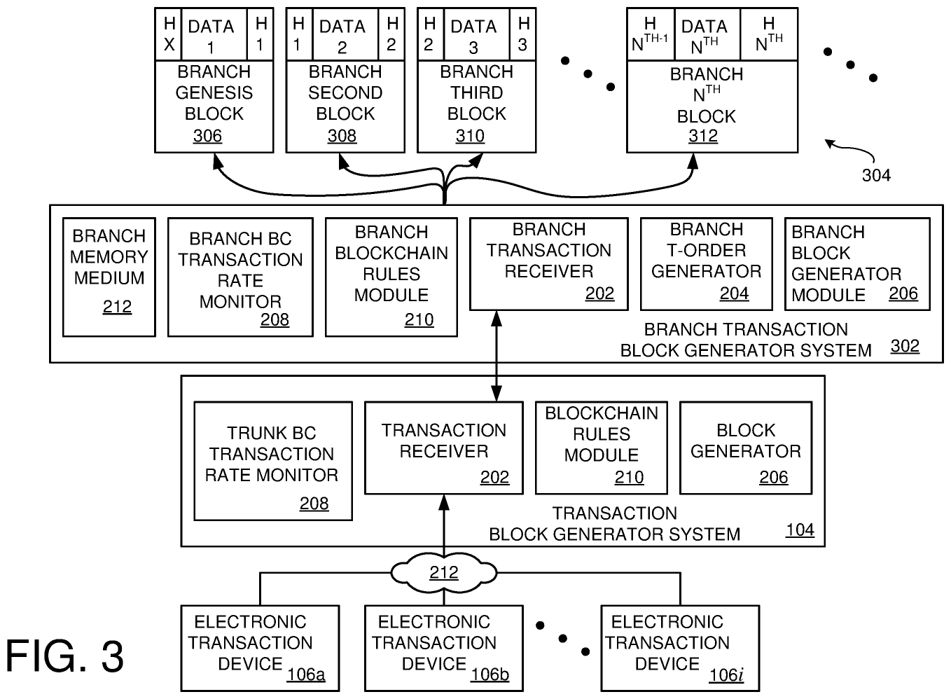

FIG. 3 is a block diagram showing additional detail of an exemplary transaction block generator system 104 and a newly created branch transaction block generator system 302. The branch transaction block generator system 302 comprises a branch transaction receiver module 202, a branch transaction order (T-Order) module 204, a branch block generator module 206, a branch blockchain (BC) transaction rate monitor module 208, a branch blockchain rules module 210, and a branch memory medium 212. The components of the branch transaction block generator system 302 are similar in operation and function as the above-described components of the transaction block generator system 104, and accordingly, have the same reference numerals that identify those components. Since the operation and functionality of the blocks of the branch transaction block generator system 302 are the same, or substantially the same, these blocks are not again described in detail. Other embodiments may include other blocks and/or modules (not shown) that provide other functionality. Alternatively, or additionally, one or more of the blocks and/or modules of FIG. 3 may be integrated together and/or may be integrated with other blocks and/or modules. In the various embodiments, the blocks and/or modules of FIG. 3 may be implemented as hardware, firmware, or a combination of hardware and firm ware. In some embodiments, the blocks and/or modules of a branch transaction block generator system 302 may be implemented in a distributed fashion using a plurality of peer-to-per devices networked together via the distributed communication network 112.

The example branch transaction block generator system 302 is illustrated and described as being separate from the transaction block generator system 104. In some embodiments, the branch transaction block generator system 302 and the transaction block generator system 104 are implemented on different computing devices. In other embodiments, the branch transaction block generator system 302 and the transaction block generator system 104 are implemented on the same computing device.

It is understood that a plurality of different branch transaction receiver modules 202 may be created on an as-needed and/or on an as-desired basis. Embodiments of the transaction tracking system 100 may have any suitable number of branch transaction block generator systems 302. New branch transaction block generator systems 302 may be generated to reduce current transaction rate saturation issues. Alternatively, or additionally, new branch transaction block generator systems 302 based on any rule of interest including for different protocols, encryption techniques, transaction processing, or access, amongst others.

A new branch transaction block generator system 302 may be created at any suitable time. For example, with increasing levels of transmission rates, a plurality of new branch transaction block generator systems 302 may be generated to control transaction rate saturation when a transaction rate saturation issue begins to occur.

Furthermore, a branch transaction block generator system 302 may even generate its own plurality of new branch transaction block generator systems 302. For example, but not limited to, at some point in time a branch transaction block generator system 302 may itself experience transaction rate saturation. To mitigate the saturation, the parent branch transaction receiver module 202 may cause the generation (e.g., instantiation) of a new child branch transaction receiver module 202 that then generates a new blockchain of selected transaction information that has been defined by the parent branch transaction block generator system 302.

In the exemplary embodiment of FIG. 3, the branch transmission receiver module 202 is communicatively coupled to the transaction receiver module 202 of the transaction block generator system 104. Here, the trunk BC transaction rate monitor module 208 may monitor the rate of remaining transaction information that is processed by the transaction order module 204 of the transaction block generator system 104. If transaction rate saturation occurs at a later time, then a new branch transaction block generator system 302 can be created, thereby alleviating the currently determined transaction rate saturation.

In alternative embodiments, the branch transaction receiver module 202 is directly communicatively coupled to one or more, or even all of, the plurality of electronic transaction devices 110a-m. As each one of the electronic transaction devices 110a-m broadcasts its particular transaction information onto the distributed communication network 112, header information or the like is included in the transaction information that specifies various characteristics about the transaction information. If a particular characteristic is used to identify transaction information that is to be used by the branch transaction block generator system 302, then the branch transaction block generator system 302 can process that particular transaction information to generate its blockchain. Other transaction information can be simply ignored by the branch transaction block generator system 302. Concurrently, the transaction block generator system 104 may simply ignore the transaction information being processed by the newly created branch transaction block generator system(s) 302 such that the remaining transaction information is processed to create a new block for the trunk blockchain 214.

Once the branch transaction block generator system 302 has been created and the branch genesis block 306 has been generated, the process of generating new blocks 308, 310, 321 continues as previously described for the generation of blocks for the trunk blockchain 214. These newly generated branch blocks are used to generate the new branch blockchain 304.

A novel departure from the prior art becomes apparent by inspection of the conceptually illustrated branch blockchain 304. In the original genesis block 216 of the original blockchain 214, there is no hash value in the genesis block (since there is no previously generated block that would otherwise have a hash value). However, the branch genesis block 306 can be referenced back to the block that was generated by the transaction block generator system 104 just prior to the creation of the new branch transaction block generator system 302. In some embodiments, this hash value (HX) is obtained from the block created by the transaction block generator system 104 (which is also incorporated into the next block of the trunk blockchain 214). This hash value is added into the branch genesis block 306 and is used in the computation of the current hash value (H1) for the branch genesis block 306. The use of the hash from the last generated block of the trunk blockchain 214 provides a means to reference the branch genesis block 306 back to its parent trunk blockchain 214 at a later time.

Another novel departure from legacy blockchain technologies is a periodic information gathering (or checkpointing) process that captures the transaction information that has been stored into the branch blockchain 304. For example, the branch block 312 may be the one hundredth block in the newly created branch blockchain 304. An example embodiment gathers all of the transaction information entries stored in the first one hundred branch blocks. Since the data stored in the blocks of the trunk blockchain 214 store any suitable data and any amount of data, this gathered transaction information from the first hundred blocks of the branch blockchain 304 may be optionally communicated back to the transaction block generator system 104 for storage in the next generated block that is incorporated into the trunk blockchain 214. Accordingly, the transaction information of the blocks of the new branch blockchain 304 are memorialized in the stored data of the next generated block of the trunk blockchain 214.

The same gathering process may later occur for the next hundred blocks of the branch blockchain 304, and so on. Here, the periodic basis for the ongoing gathering processes is based on a predefined number of generated blocks (one hundred blocks in this simplified hypothetical example). Any suitable number of blocks may be used for initiating a transaction information gather process. Alternatively, a predefined duration or time may be used for initiating a transaction information gathering process. In other embodiments a different size portion of data may be communicated back to be incorporated into the trunk blockchain, including for example, just the latest branch block 312.

Another novel departure from legacy blockchain technologies is that a branch blockchain 304 may end. When generation of a branch blockchain 304 ends, a final gathering process occurs in an example embodiment, and the transaction information from the final gathering may be communicated back to the transaction block generator system 104 for incorporation into the next generated block of the trunk blockchain 214.

Alternatively, generation of new blocks for the branch blockchain 304 may cease. Information identifying the last generated block in the branch blockchain 304 is communicated to the transaction block generator system 104 for incorporation into the next block that is generated for the trunk blockchain 214. Accordingly, the end of the branch blockchain 304 can be memorialized in the trunk blockchain 214

When generation of a branch blockchain 304 ends, the branch transaction block generator system 302 may be closed. That is, the device running the branch transaction block generator system 302 may stop generating blocks for the branch blockchain 304, and then may start other processes and operations that are unrelated to the branch transaction block generator system 302.

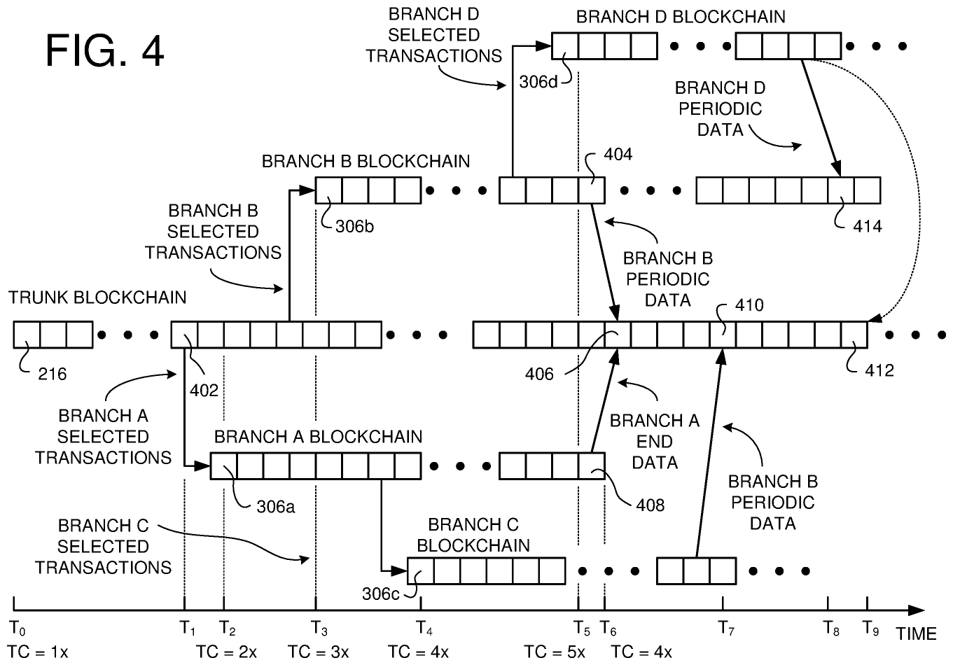

FIG. 4 is a conceptual illustration of a hypothetical trunk blockchain and a plurality of branch blockchains that are generated for the trunk blockchain at various times. As with any blockchain, the very first block 216 of the trunk blockchain is the genesis block 216 (see also FIG. 2). With respect to the illustrated time scale, the genesis time of T₀ indicates the formation of the trunk blockchain genesis block 216.

At some point in time, conceptually illustrated as T₁, an event occurs that necessitates the formation of a first branch blockchain, denoted as “Branch A Blockchain” in FIG. 4. To conceptually illustrate an operational scenario, the sequence of branch blockchain generation processes are described in the context of solving the saturation problem encountered in legacy blockchain systems. However, one skilled in the art appreciates that with embodiments of the transaction tracking system 100, a branch blockchain may be initiated in response to any particular event or rule.

For discussion purposes, assume that at some time prior to the conceptually illustrated time T₁, the trunk transaction block generator system 104, which is generating the trunk blockchain reaches or nears a transaction rate saturation level. The trunk transaction block generator system 104 then causes generation of a new branch transaction block generator system 302 (FIG. 3) such that the newly created branch transaction block generator system 302 is able to generate a new blockchain (denoted as Branch A Blockchain) at a time T₂. Then, the trunk transaction block generator system 104 designates a portion of the incoming transaction information (denoted as the “branch A selected transactions”) that is to be managed by the newly formed branch transaction block generator system 302 and stored in the Branch A Blockchain.

After generation of the block 402 in the trunk blockchain, the ending hash value of that block 402 is computed. Then, that hash value (and any other suitable information that is desired to be stored in the initial genesis block 306a) is provided to the newly created branch transaction block generator system 302. Depending upon the embodiment, transaction information is acquired by the newly generated branch transaction block generator system 302 such that the new genesis block 306a (see also FIG. 3) is generated to store the acquired transaction information. This genesis block 306a contains the hash value of the trunk block 402, any provided information intended for storage in the genesis block 306a, the acquired transaction information (stored as one or more unique transaction entries), and the computed hash value of the new genesis block 306a (as previously discussed with reference to FIG. 3 and potentially using the rules associated with that branch).

With respect to the saturation problem, after formation of the Branch A Blockchain, total transaction rate capacity (TC) has increased. Here, the maximum total transaction rate capacity, conceptually illustrated at time T₂, will be two times (TC=2×) the transaction rate capacity of the original trunk branch since a new branch transaction block generator system 302 is available to take over management of a portion of the incoming transaction information (assuming that the technologies used by both transaction block generator systems are the same or are substantially the same). However, the increase of the actual total transaction rate capacity will vary depending upon the amount of incoming (newly received) transaction information that is offloaded to the new branch transaction block generator system 302 that is generating and managing the Branch A Blockchain.

Continuing with the hypothetical operation example of FIG. 4, assume that a time that is conceptually illustrated at time just prior to T₃, the trunk transaction block generator system 104 which is generating the trunk blockchain again becomes saturated. To reduce the transaction rate saturation, a second branch transaction block generator system 302 is executed (and/or initiated as necessary) to create a new second blockchain (denoted as Branch B Blockchain in FIG. 4). Here, a porting on the incoming transaction information (denoted as the “branch B selected transactions) is designated to be handled by the second trunk transaction block generator system 104. At some point in time, conceptually illustrated at a time T₃, a first new genesis block 306b is generated by the second branch transaction block generator system 302.

The above-described processes and effects for the first Branch A Blockchain are equally applicable to the newly generated second Branch B Blockchain and the second branch transaction block generator system 302. Here, the theoretical maximum total transaction rate capacity is three times (TC=3×) the original transaction rate capacity of the trunk transaction block generator system 104 that is generating the trunk blockchain.

As noted herein, any branch transaction block generator system 302 may itself cause the execution/initiation of a new branch transaction block generator system 302 that then generates a branch blockchain. Here, the originating branch transaction block generator system 302 may be referred to as a “parent” branch transaction block generator system 302 and the newly created branch transaction block generator system 302 may be referred to as a “child” branch transaction block generator system 302 (though any suitable nomenclature to identify particular branch transaction block generator systems 302 may be used in the various embodiments). Of note, depending upon the implementation, instantiations of separate block generator systems (trunk or branch) may be made each time a branch is initiated, one system may be used to handle the formation of all new branches, or one or more generators may be pooled and then executed as needed, or the like. Other implementations are possible and contemplated.

To illustrate formation of a child branch blockchain by a parent branch blockchain, at some time prior to T₄, assume that the branch transaction block generator system 302 that is managing the Branch A Blockchain becomes saturated or is nearing a point of saturation. In response, the branch transaction block generator system 302 that is managing the Branch A Blockchain may initiate creation of a new child branch transaction block generator system 302. The newly generated child branch transaction block generator system 302 would then generate a new blockchain, denoted as the Branch C Blockchain in FIG. 4. Here, the genesis block 306c is created, thereby initiating the formation of the new Branch C Blockchain (similar to the above-described process for the Branch A Blockchain). Here, a portion of the incoming transaction information is offloaded from the branch transaction block generator system 302 that is managing the Branch A Blockchain to the newly formed child branch transaction block generator system 302.

Similarly, at some time prior to the time T₅, the second branch transaction block generator system 302 that is managing the Branch B Blockchain may be at or nearing saturation, and then may similarly cause the creations of a new branch transaction block generator system 302 that is generating and managing the Branch D Blockchain. Its respective genesis block 306d is similarly configured as other genesis blocks 306.

At this juncture in the hypothetical example illustrated in FIG. 4, there are five operational blockchains that are processing and storing incoming transaction information. The maximum hypothetical total transaction rate capacity at this time is five times (TC=5×) the transaction rate capacity of the original the trunk transaction block generator system 104 which is generating the trunk blockchain.

A novel feature provided by some embodiments of the transaction tracking system 100 is a periodic information gathering (or checkpointing) process whereby a determined portion (some or all of the) information stored in a branch blockchain is gathered and is then communicated back to the trunk transaction block generator system 104 which is generating the trunk blockchain. This gathered information may then be stored into the next generated block of the trunk blockchain.

To conceptually illustrate this gathering process, assume that at a time T₅, the branch transaction block generator system 302 that is managing the Branch B Blockchain gathers selected information, such as the information residing in the block 404 (or all of or selected transaction information that has been stored in all or any of the generated blocks of the Branch A Blockchain). The gathered information (denoted as the “branch B periodic data” in FIG. 4) is communicated to the trunk transaction block generator system 104 which is generating the trunk blockchain and is then incorporated into the block 406 that then becomes part of the trunk blockchain. This periodic process of gathering data from the Branch B Blockchain, communicating the gathered information to the trunk transaction block generator system 104 which is generating the trunk blockchain, and incorporating the gathered data into a new block that becomes part of the trunk blockchain, may be periodically repeated and/or may occur at any desired point in time. Of note, due to the nature of blockchains, prior information is considered immutable, so the gathering/checkpointing of information is made to a newly created block.

Another novel feature of embodiments of the transaction tracking system 100 is that at any suitable point, the process of generating and managing a branch blockchain may end. For example, at a time T₅, a determination may be made that the Branch A Blockchain is no longer needed. The block 408 is the last generated block, denoted as an end block, of the Branch A Blockchain. After generation of the end block 408, various information of interest is gathered and is communicated back to the trunk transaction block generator system 104 which is generating the trunk blockchain. Similar to the periodic gathering process described herein, any suitable transaction information and/or information of interest may be communicated by the branch transaction block generator system 302 that is managing the Branch A Blockchain to the trunk transaction block generator system 104 which is generating the trunk blockchain. This information (denoted as the “branch A end data” in FIG. 4) may then be incorporated into a block, such as the example block 406, that is then added as a member of the trunk blockchain.

Further, one skilled in the art appreciates that ending a child blockchain will result in a reduction of the maximum available transaction rate capacity. Such a situation may be desirable to conserve computing resources and/or memory storage resources. With respect to FIG. 4, the total transaction rate capacity is reduced to four times (TC=4×) the capacity after Branch A Blockchain ends.

In some embodiments, the Branch A Blockchain that has been communicated to and stored by the blockchain P2P nodes 108 is retained by the P2P nodes after the ending of a branch blockchain. In this example situation of FIG. 4, the information that is communicated from the branch transaction block generator system 302 (that is managing the Branch A Blockchain) to the trunk transaction block generator system 104 (which is generating the trunk blockchain) is stored in a block that is added to the trunk blockchain. Here, the stored information memorializes all of, or part of, the transaction information stored in the Branch A Blockchain. Accordingly, a level of redundancy is provided for the Branch A Blockchain.

Alternatively, some embodiments of the transaction tracking system 100 may allow the Branch A Blockchain deleted since all of the information stored into the Branch A Blockchain has been added into a block that is incorporated into the trunk blockchain. For instance, the blockchain P2P nodes 108 that have stored the Branch A Blockchain may delete, erase or otherwise over-write the stored Branch A Blockchain. Here, memory storage capacity of the blockchain P2P nodes 108 may thereby be optimized since the transaction information has been entirely memorialized in the trunk blockchain.

In some embodiments, a gathering process may be performed on a child branch blockchain, and the gathered information may be communicated to the trunk transaction block generator system 104 (which is generating the trunk blockchain) for incorporation into a block of the trunk blockchain. For example, at a time T₇, a gathering process is performed by the branch transaction block generator system 302 that is managing the Branch C Blockchain. The information may then be incorporated into a block 410, for example, that is being generated by the trunk transaction block generator system 104.

In some situations, a gathering process may be performed on a child branch blockchain, and the gathered information may be communicated to one or more branch transaction block generator systems 302 and potentially to the trunk transaction block generator system 104 as well, which is generating the trunk blockchain. The communicated information is incorporated into blocks of one or more branch blockchains and potentially into a block of the trunk blockchain. For example, at a time T₈, a gathering process is performed by the branch transaction block generator system 302 that is managing the Branch D Blockchain. The information is communicated to the branch transaction block generator system 302 that is managing the Branch B Blockchain and (optionally as shown) to the trunk transaction block generator system 104 which is generating the trunk blockchain. The information may then be incorporated into block 414, for example, that is being generated by the branch transaction block generator system 302 that is managing the Branch B Blockchain. The information may also be incorporated into block 412, for example, that is being generated by the trunk transaction block generator system 104. In other scenarios the gathering process does not update the trunk blockchain, but only one or more branch blockchains.

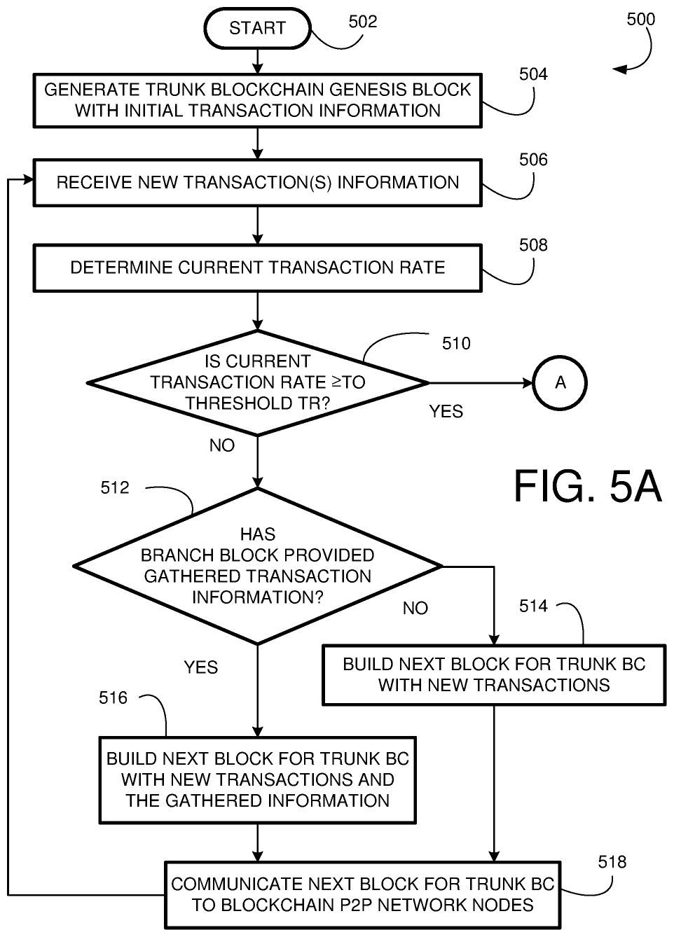

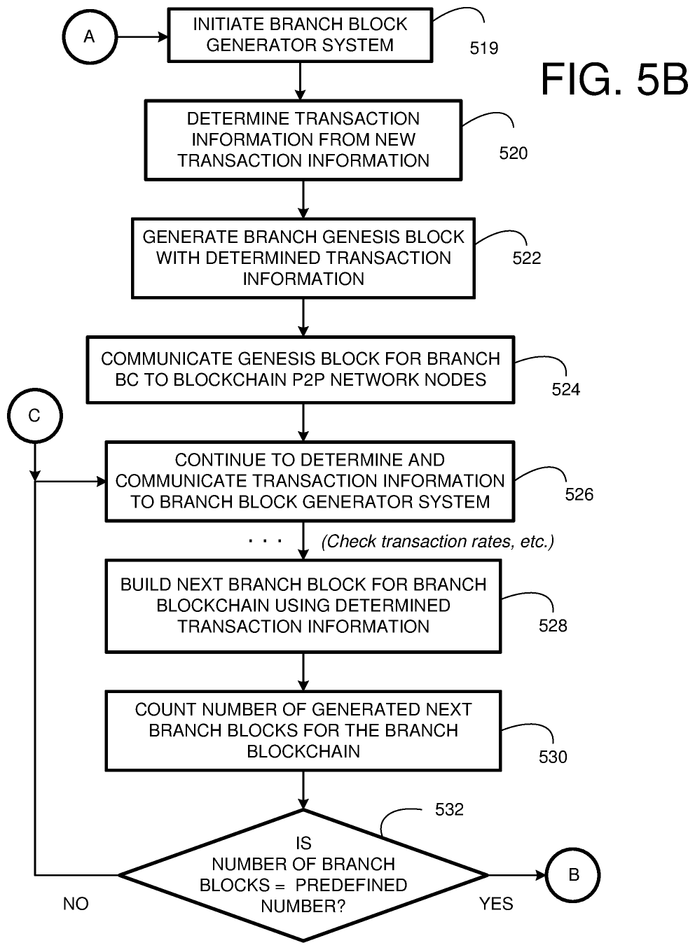

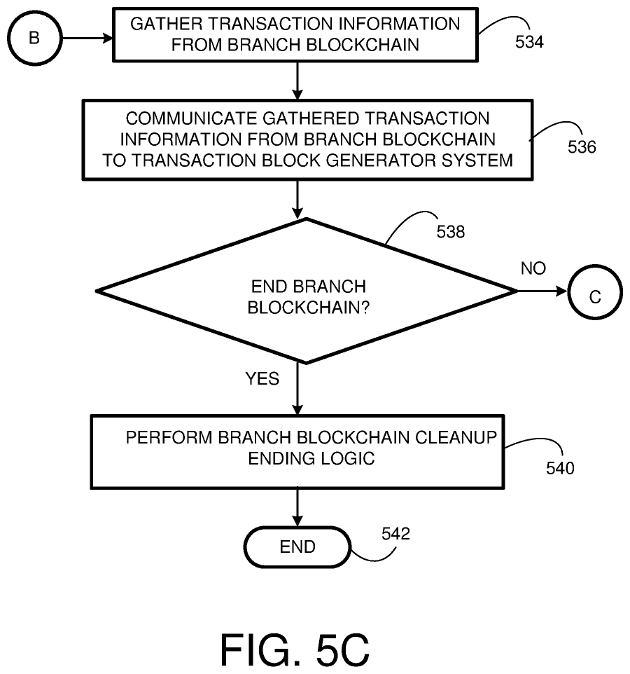

FIGS. 5A, 5B and 5C are a flow chart 500 describing an exemplary process performed by an example embodiment of the transaction tracking system 100. The flowchart 500 shows the architecture, functionality, and operation of a possible implementation of the software for implementing the transaction tracking system 100. In this regard, each block may represent a module, segment, or portion of code, which comprises one or more executable instructions for implementing the specified logical function(s). It should also be noted that in some alternative implementations, the logic noted in the blocks may occur out of the order noted in FIGS. 5A, 5B and 5C, may include additional logic, and/or may omit some logic. For example, two blocks shown in succession in FIGS. 5A, 5B and 5C may in fact be executed substantially concurrently, the blocks may sometimes be executed in the reverse order, or some of the blocks may not be executed in all instances, depending upon the functionality involved. All such modifications and variations are intended to be included herein within the scope of this disclosure.

With respect to FIGS. 5A, 5B and 5C, the process of flow chart 500 starts at block 502, for example, in response to the initiation of a trunk transaction block generator system 104 which is generating a trunk blockchain. At block 504, the genesis block with the initial transaction information is generated, which is broadcast out (or communicated in some manner) to the blockchain P2P nodes 108 to initiate formation of the trunk blockchain (for example, by performing verification as part of blockchain consensus algorithms). At block 506, new transaction information is acquired by the trunk transaction block generator system 104. One skilled in the art appreciates that the new transaction information may be viewed as stream of transaction data each associated with a particular transaction. In some implementations the transaction data may be buffered. At times, multiple transaction data each associated with a different transactions may be received in the streaming data by the trunk transaction block generator system 104.

At block 508, a current transaction rate (or actual transaction rate) is computed. Here, the current transaction rate corresponds to the number of individual transaction data each associated with a particular transaction during some predefined duration, such as one second or the like.

At block 510, a determination is made whether the current transaction rate is equal to or greater than a predefined transaction rate threshold. If at block 510 the current transaction rate is less than the transaction rate threshold (the NO condition), the process proceeds to block 512. It is appreciated that the transaction rate threshold is defined to be less than an actual maximum transaction rate limit to avoid potential failure problems in the event that the current transaction rate reaches and then exceeds the maximum transaction rate.

At block 512, a determination is made whether the branch transaction block generator system 302 has performed a gathering process and has provided transactional information (checkpoint information) to the trunk transaction block generator system 104. If no gathered transaction information has been provided, the NO condition, a next block is built using the received new transactions at block 514. If gathered transaction information has been provided, the YES condition, a next block is built using the new transactions and the gathered transaction information at block 516.

After blocks 514 and 516, the process proceeds to block 518 where the next built block for the trunk blockchain is communicated (e.g., via broadcast or other messaging protocol) to the blockchain PnP network nodes 108 via the distributed communication networks 112. This communicated next block, after verification and/or validation will be eventually added as a new member of the trunk blockchain. Processing then returns to the process the next received transaction information at block 506.

If at block 510 the current transaction rate is equal to or mare than the transaction rate threshold (the YES condition), the process proceeds to block 519 (see FIG. 5B). At block 519, operation of a branch transaction block generator system 302 is initiated. At block 520, the trunk transaction block generator system 104 determines what newly received transaction information is to be processed by the branch transaction block generator system 302. As explained above, this determination may be based upon transaction rate or other characteristics such as those defined by a blockchain rules module. This first portion of the determined transaction information is communicated to the branch transaction block generator system 302. Since the branch transaction block generator system 302 has just been initiated, a branch genesis block is generated at block 522 with the determined transaction information from the initially received transaction information. At block 524, the branch genesis block for the new branch blockchain is communicated to the blockchain PnP network nodes 108 via the distributed communication networks 112. This communicated branch genesis block, after verification and/or validation will be eventually added as the first member of the branch blockchain.

At block 526, the trunk transaction block generator system 104 continues to communicate transaction information to the branch transaction block generator system 302 (that has been determined to be processed by the branch transaction block generator system 302). In practice, the continuous incoming stream of transaction data, each associated with a particular transaction, are evaluated such that a stream of determined transactions that is to be processed by the branch transaction block generator system 302 is communicated (as a stream) from the trunk transaction block generator system 104 to the branch transaction block generator system 302. (As noted herein, other embodiments may employ other means of providing the determined transaction information to the branch transaction block generator system 302.)

In some embodiments, additional logic may be performed at this point. For example, the transaction rate is also monitored at the branch transaction block generator system 302. Accordingly, the flow chart 500 could be modified to show this transaction rate monitoring process which would be similar to the above described transaction rate monitoring process conducted for the trunk transaction block generator system 104. However, for brevity, such blocks are omitted in FIG. 5B.

At block 528, a next branch block is constructed using the newly acquired determined transaction information (that is, the transaction information in the stream that has been determined to be processed by the branch transaction block generator system 302). Then, the generated next branch block is counted at block 530. There are many ways that the count of the built branch blocks could be tracked. For example, but not limited to, a counter could be incremented each time a new branch block is built. One reason for counting these blocks is for gathering information to communicate back to the trunk block generator system (or a parent block generator system).

At block 532, a determination is made whether the number of branch blocks is equally to a predefined number, or a multiple thereof. In a previously described embodiment, the predefined number of branch blocks was one hundred. Accordingly, every one hundredth branch block is identifiable. Any suitable predefined number, or even a time duration, may be used by the various embodiments. If the branch block number is not equal to the predefined number or a multiple thereof, the NO condition, the process returns to block 526 to process next transaction information. However, if the branch block number is equal to the predefined number or a multiple thereof, the YES condition, the process proceeds to block 534 (see FIG. 5C).

At block 534 selected transaction information of previously generated branch blocks is gathered by the branch transaction block generator system 302. At block 536, the gathered transaction information is communicated from the branch transaction block generator system 302 to a parent transaction block generator system (for example, the trunk block generator system 104). See block 512 for an explanation of how the gathered transaction information, once received by the trunk transaction block generator system 104, is processed. This gathering process, also referred to herein as a checkpoint process, may be used to memorialize the transaction information of a branch blockchain.

The process proceeds to block 538 where a determination is made whether to end the branch blockchain. If the operation of the branch blockchain is to end, the YES condition, the process proceeds to block 540 where various branch blockchain cleanup ending logic processes are performed (such as to archive the blockchain information or other information, release resources, and the like). The process ends at block 542. However, if the operation of the branch blockchain is to continue, the process proceeds back to block 526 (see FIG. 5B).

In some situations, once the newly received transaction information designated for the branch transaction block generator system 302 has been selected and communicated from the trunk transaction block generator system 104 to the branch transaction block generator system 302, there may be periods of time where there is no remaining transaction information for the trunk transaction block generator system 104 to process. In some embodiments, when the there is no transaction information to be processed during the current period of time by the trunk transaction block generator system 104, null blocks are generated. These null blocks simply contain no transaction information. Alternatively, some embodiments simply do not generate a block at the end of the predefined time period. Rather, such embodiments wait for receipt of transaction information that is to be processed by the trunk transaction block generator system 104, and then generate a corresponding block. In these instances, the trunk transaction block generator system 104 may be considered to be operating in an idle state (or a similar inactive state).

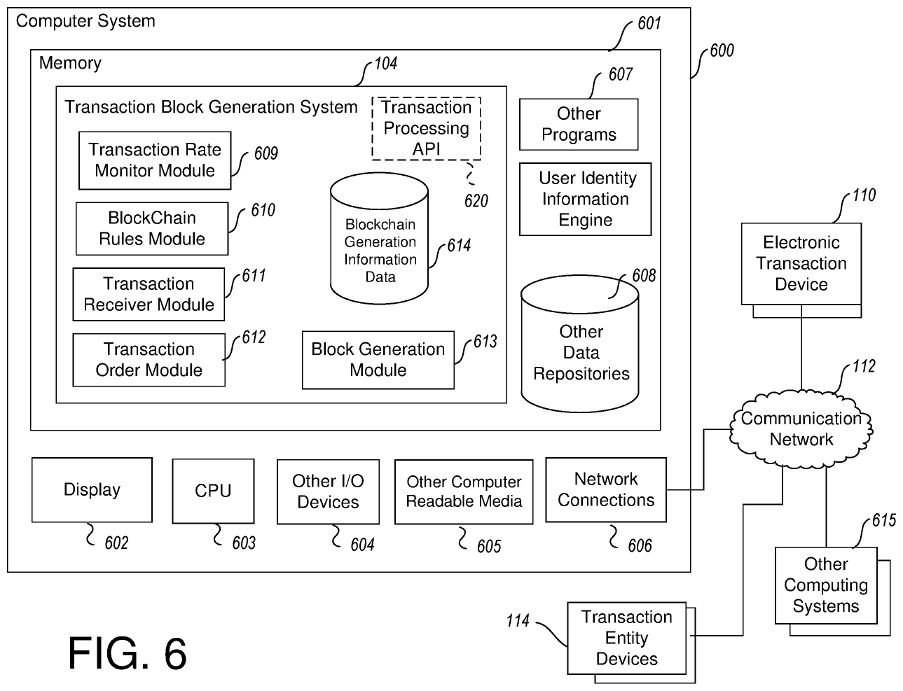

FIG. 6 is an example block diagram of an example computing system that may be used to practice embodiments of a transaction block generator system 104 described herein. Note that one or more general purpose virtual or physical computing systems suitably instructed or a special purpose computing system may be used to implement embodiments of a transaction block generator system 104. Further, the transaction block generator system 104 may be implemented in software, hardware, firmware, or in some combination to achieve the capabilities described herein. However, just because it is possible to implement the transaction block generator system 104 on a general purpose computing system does not mean that the techniques themselves or the operations required to implement the techniques are conventional or well known.

The computing system 600 may comprise one or more server and/or client computing systems and may span distributed locations. In addition, each block shown may represent one or more such blocks as appropriate to a specific embodiment or may be combined with other blocks. Moreover, the various blocks of the transaction block generator system 104 may physically reside on one or more machines, which use standard (e.g., TCP/IP) or proprietary interprocess communication mechanisms to communicate with each other.

In the embodiment shown, computer system 600 comprises a computer memory (“memory”) 601, a display 602, one or more Central Processing Units (“CPU”) 603, Input/Output (I/O) devices 604 (e.g., keyboard, mouse, CRT or LCD display, etc.), other computer-readable media 605, and one or more network connections 606. The transaction block generator system 104 is shown residing in memory 601. In other embodiments, some portion of the contents, some of, or all of the components of the transaction block generator system 104 may be stored on and/or transmitted over the other computer-readable media 605. The components of the transaction block generator system 104 preferably execute on one or more CPUs 603 and manage the generation of blocks that are in a blockchain, as described herein. Other code or programs 630 and potentially other data repositories, such as data repository 608, also reside in the memory 601, and preferably execute on one or more CPUs 603. Of note, one or more of the components in FIG. 6 may not be present in any specific implementation. For example, some embodiments embedded in other software may not provide means for user input or display.

In a typical embodiment, the transaction block generator system 104 includes one or more transaction rate monitor modules 609, one or more blockchain rules modules 610, or more transaction receiver modules 611, one or more transaction order modules 612, and one or more block generation modules 613. In at least some embodiments, one or more of the modules are optionally provided external to the transaction block generator system 104 and are available, potentially, over one or more distributed communication networks 112. For example, the blockchain rules modules 610 may be provided by an external system such as one belonging to a third party desiring to determine rules for its own blockchain implementations. Other and/or different modules may be implemented. In addition, the transaction block generator system 104 may interact via the distributed communication network 112 with one or more electronic transaction devices 110, one or more transaction entity devices 114, and/or one or more third-party information provider computer systems 615, such as purveyors of information used in blockchain generation information data repository 614. Also, of note, the blockchain generation information data repository 614 may be provided external to the transaction block generator system 104 as well, for example in a WWW knowledge base accessible over one or more distributed communication networks 112. In an exemplary embodiment the blockchain generation information data repository 614 may include the transaction information (for example, as it is streamed in), checkpoint information from branches, metadata information used to generate blocks, and the like.

In an example embodiment, components/modules of the transaction block generator system 104 are implemented using standard programming techniques. For example, the transaction block generator system 104 may be implemented as a “native” executable running on the CPU 603, along with one or more static or dynamic libraries. In other embodiments, the transaction block generator system 104 may be implemented as instructions processed by a virtual machine. In the various embodiments, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported. Also, other functions could be implemented and/or performed by each component/module, and in different orders, and in different components/modules, yet still achieve the described functions.

In addition, programming interfaces to the data stored as part of the transaction block generator system 104 (e.g., in the data repositories 614) can be available by standard mechanisms such as through C, C++, C#, and Java APIs; libraries for accessing files, databases, or other data repositories; through scripting languages such as XML; or through Web servers, FTP servers, or other types of servers providing access to stored data. The blockchain generation information data repository 614 may be implemented as one or more database systems, file systems, or any other technique for storing such information, or any combination of the above, including implementations using distributed computing techniques. In addition, embodiments of the blockchain generation information data repository 614 or the transaction block generator system 104 may be implemented as stored procedures, or methods attached to selected “objects,” although other techniques may be equally effective.

Additionally, or alternatively, the example transaction block generator system 104 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of a transaction block generator system 104.

Furthermore, in some embodiments, some or all of the components of the transaction block generator system 104 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It should be emphasized that the above-described embodiments of the transaction tracking system 100 are merely possible examples of implementations of the invention. Many variations and modifications may be made to the above-described embodiments. All such modifications and variations are intended to be included herein within the scope of this disclosure and protected by the following claims.

1. A computer-implemented method for transaction tracking using a transaction block generation system, the method comprising:
adding a trunk block to a trunk blockchain data structure stored in a memory that is comprised of a plurality of blocks, wherein each added block of the trunk chain comprises a first hash value of a preceding block, transaction information, and a second hash value that is computed based on the contents of the respective trunk block;
receiving new transaction information over some predefined duration at the trunk transaction block generation system;
determining a current transaction rate that corresponds to a rate at which the transaction information is currently being received by the trunk transaction block generation system;
comparing the current transaction rate with a transaction rate threshold;
executing a branch transaction block generation system in response to the current transaction rate exceeding the transaction rate threshold;
determining a portion of the newly received transaction information that is being received at the trunk transaction block generation system; and
communicating the determined newly received transaction information from the trunk transaction block generation system to the branch transaction block generation system,
wherein the branch transaction block generation system generates a first genesis branch block that includes at least the determined newly received transaction information, a third hash value that corresponds to the second hash value of the most recently generated trunk block that was generated by the transaction block generation system, and a fourth hash value that is computed based on the, and
wherein the generated branch genesis block is a first block of a new branch blockchain that is being generated by the branch transaction block generation system.

2. The method of claim 1 configured to support an unlimited transaction rate system.

3. The method of claim 1, further comprising:
checkpointing at least a portion of the new branch block chain into a parent transaction block generator system.

4. The method of claim 1 wherein the method can be used by multiple tenant systems.

5. The method of claim 4 wherein the multiple tenant systems include handling different financial processing systems, protocols, privacy requirements, and/or security requirements.

6. A transaction block generation computer system configured to execute instructions to control a computer processor to perform the method of claim 1.
